(19) United States
(12) Patent Application Publication
(10) Pub. No.: US 2015/0327322 A1
(43) Pub. Date: Nov. 12, 2015

(54) SYSTEMS, DEVICES, AND METHODS FOR ALIGNMENT PROCEDURES IN DUAL-CONNECTIVITY NETWORKS

(71) Applicant: Intel IP Corporation, Santa Clara, CA (US)

(72) Inventors: Rui Huang, Beijing (CN); Yang Tang, Pleasanton, CA (US); Yujian Zhang, Beijing (CN); Candy Yiu, Portland, OR (US)

(21) Appl. No.: 14/481,508

(22) Filed: Sep. 9, 2014

Related U.S. Application Data
(60) Provisional application No. 61/990,682, filed on May 8, 2014.

(51) Int. Cl. H04W 76/04

(52) U.S. Cl. CPC H04W 76/048

(57) ABSTRACT

Embodiments of the present disclosure describe systems, devices, and methods for alignment procedures in dual-connectivity networks. Various embodiments may include determining system frame number and subframe number differences, and aligning discontinuous reception (DRX) or measurement gaps of a secondary cell group with a master cell group. Other embodiments may be described or claimed.

### CROSS-REFERENCE TO RELATED APPLICATION

This application claims the benefit of U.S. Provisional Application No. 61/990,682 filed May 8, 2014, entitled “ONE MEASUREMENT METHOD OF LTE DUAL CONNECTIVITY;” the entirety of the above listed application is hereby incorporated reference.

### FIELD

Embodiments of the present disclosure generally relate to the field of wireless communication, and more particularly, to alignment procedures in dual-connectivity networks.

### BACKGROUND

In Long Term Evolution (LTE) networks, dual connectivity (DC) is used to refer to operation where a given user equipment (UE) consumes radio resources provided by at least two different access nodes connected with a non-ideal backhaul. The two access nodes, which may be referred to as a master enhanced node B (MeNB) and a secondary enhanced node B (SeNB), may be unsynchronized. This may result in various challenges to management of network resources.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a wireless communication environment in accordance with various embodiments.

FIG. 2 is a message flow illustrating a network-based configuration in a dual connectivity environment in accordance with various embodiments.

FIG. 3 is a message flow illustrating another network-based configuration in a dual connectivity environment.

FIG. 4 is a message flow illustrating a UE-based configuration in a dual connectivity environment.

FIG. 5 is a message flow illustrating another UE-based configuration in a dual connectivity environment.

FIG. 6 is a block diagram of an example computing device that may be used to practice various embodiments described herein.

### DETAILED DESCRIPTION

In the following detailed description, reference is made to the accompanying drawings, which form a part hereof wherein like numerals designate like parts throughout, and in which is shown by way of illustration embodiments that may be practiced. It is to be understood that other embodiments may be utilized and structural or logical changes may be made without departing from the scope of the present disclosure.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed or described operations may be omitted in additional embodiments.

For the purposes of the present disclosure, the term “or” is used as an inclusive term to mean at least one of the components coupled with the term. For example, the phrase “A or B” means (A), (B), or (A and B); and the phrase “A, B, or C” means (A), (B), (C), (A and B), (A and C), (B and C), or (A, B, and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “circuitry” may refer to, be part of, or include an Application Specific Integrated Circuit (ASIC), an electronic circuit, a processor (shared, dedicated, or group), or memory (shared, dedicated, or group) that execute one or more software or firmware programs, a combinational logic circuit, or other suitable hardware components that provide the described functionality.

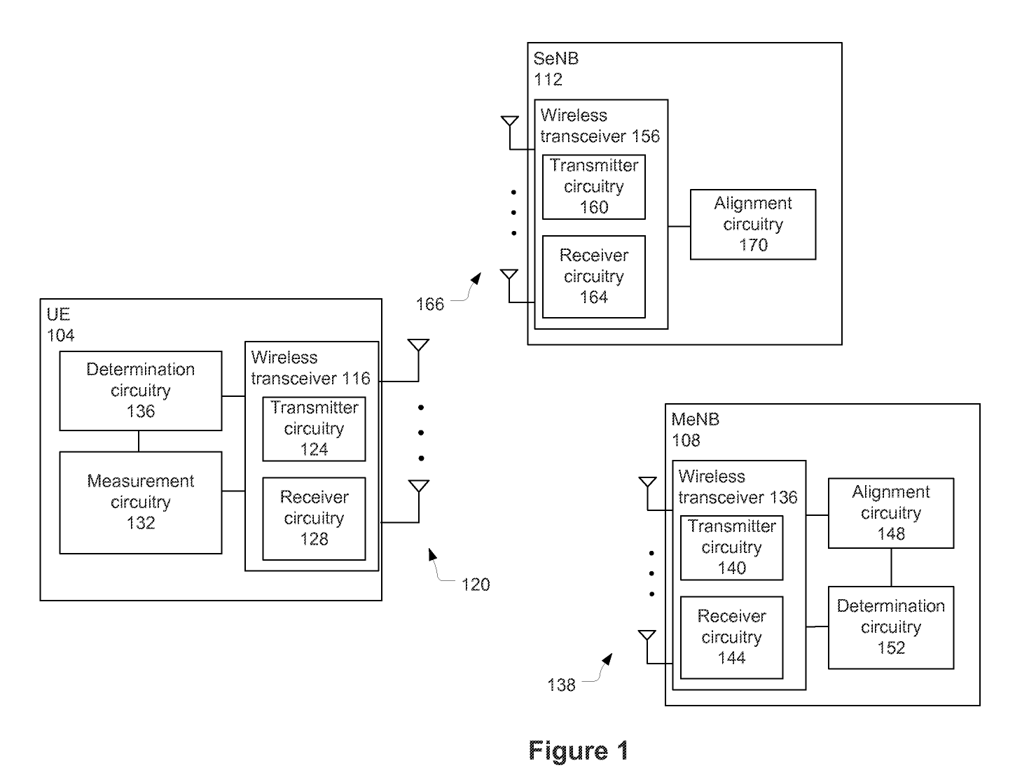

FIG. 1 schematically illustrates a dual-connectivity wireless communication environment 100 in accordance with various embodiments. The environment 100 may include a user equipment (UE) 104 in wireless communication with two access nodes, such as MeNB 108 and SeNB 112. The access nodes may be part of a 3rd Generation Partnership Project (3GPP) long-term evolution (LTE) network (or an LTE-Advanced (LTE-A) network). In particular, the access nodes may be part of one or more radio access networks (RANs) of the LTE/LTE-A network, such as one or more evolved universal terrestrial radio access networks (E-UTRANs). The E-UTRANs may be coupled with a core network such as an Evolved Packet Core (EPC) that performs various management and control functions of the LTE/LTE-A network. For example, the EPC may include a mobility management entity (MME) that is responsible for idle-mode UE paging and tagging procedures including retransmissions. The EPC may also provide a communication interface between various RANs and other networks.

The MeNB 108 and the SeNB 112 may be communicatively coupled with each other through a non-ideal backhaul channel. The backhaul channel may be a direct channel between the two access nodes or may be an indirect channel through, for example, the EPC. In various embodiments, the MeNB 108 and the SeNB 112 may include additional, non-wireless communication interfaces to facilitate communication with entities of the EPC.

The MeNB 108 may be associated with a group of serving cells referred to as a master cell group (MCG). The MeNB 108 may be the eNB that interfaces with various entities of the EPC control functions within the environment 100 with respect to communications with the UE 104. For example, the MeNB 108 may terminate an S1-MME interface and, therefore, act as a mobility anchor towards the EPC.

The SeNB 112 may be associated with a group of serving cells referred to as a secondary cell group (SCG). The SeNB 108 may provide additional radio resources for the UE 104. Operation of the SeNB 108, with respect to the communications of UE 104, may be controlled by the MeNB 108. For example, if the SeNB 112 wants to modify a configuration of cells within the SCG, the SeNB 112 may transmit an appropriate SCG modification request to the MeNB 108. The MeNB 108 may determine whether the requested modifications are approved and instruct the SeNB 112 accordingly.

The cells in the MCG may be unsynchronized with those in the SCG. Therefore, a system frame number (SFN) or subframe in the MCG may not be the same as the SFN or subframe in the SCG. This may lead to problems when uplink/downlink communications from/to the UE 104 need to be limited. For example, in some embodiments a measurement gap may define a period of time in which no uplink or downlink transmissions will be scheduled for the UE 104. This may allow the UE to perform various radio resource management (RRM) measurements. The RRM measurements may include, for example, inter-frequency measurements, including cell identification, that may support E-UTRAN inter-frequency cell search. If the measurement gap provided by the SeNB 112 is not aligned with the measurement gap provided by the MeNB 108, uplink or downlink transmissions may be scheduled during a period of time in which the UE 104 is performing the RRM measurements. For another example, in some embodiments the UE 104 may enter a discontinuous reception (DRX) state for a period of time by powering down communication circuitry as scheduled by, for example, the MeNB 108. If the SNF or subframe of the SCG is not aligned with the corresponding SNF or subframe of the MCG, the SCG may schedule downlink transmissions for the UE 104 when the UE 104 is powered down according to the DRX schedule. Accordingly, various embodiments describe determination of the differences between the SFN/subframes of the MCG and the SCG to facilitate alignment of DRX or measurement gaps of the MCG and SCG.

The UE 104 may include a wireless transceiver 116 that facilitates over-the-air communication via one or more antennas 120. The wireless transceiver 116 may include transmitter circuitry 124 and receiver circuitry 128 that are respectively configured to provide transmit and receive functions such as, but not limited to, amplification, up/down converting, filtering, etc.

The UE 104 may further include measurement circuitry 132 that is coupled with the wireless transceiver 116. The measurement circuitry 132 may be configured to provide the RRM measurements. The RRM measurements may be based on indications of measurement gaps communicated to the UE 104 by the MeNB 108 or the SeNB 112.

In some embodiments, the UE may further include determination circuitry 136 coupled with the wireless transceiver 116 and the measurement circuitry 132. The determination circuitry 136 may determine SFN or subframe differences between the MCG and the SCG to facilitate alignment of DRX or measurement gap of the MCG and the SCG.

The MeNB 108 may include a wireless transceiver 136 that facilitates over-the-air communication via one or more antennas 138. The wireless transceiver 136 may include transmitter circuitry 140 and receiver circuitry 144. Similar to transmitter circuitry 124 and receiver circuitry 128, the transmitter circuitry 140 and receiver circuitry 144 may be respectively configured to provide transmit and receive functions such as, but not limited to, amplification, up/down converting, filtering, etc.

The MeNB 108 may further include alignment circuitry 148 coupled with the wireless transceiver 136. The alignment circuitry 148 may be configured to align a DRX or measurement gap of the SCG with a DRX or measurement gap of the MCG. In various embodiments, as will be discussed in further detail below, alignment of the DRX or measurement gap may be done through configuring of a gap offset that is provided to the SeNB 112.

In some embodiments, the MeNB 108 may further include determination circuitry 152 coupled with the alignment circuitry 148 and the wireless transceiver 136. The determination circuitry 152 may be configured to determine a difference between the SFNs or subframes of the MCG and SCG. The determined differences may form the basis for the configuration of the gap offset.

The SeNB 112 may include a wireless transceiver 156 including transmitter circuitry 160 and receiver circuitry 164 coupled with one or more antennas 166. The wireless transceiver 156 may operate similar to wireless transceiver 136 described above with respect to the MeNB 108.

The SeNB 112 may further include alignment circuitry 170 coupled with the wireless transceiver 156. The alignment circuitry 170 may align a DRX or measurement gap of the SCG with a corresponding DRX or measurement gap of the MCG. The alignment may be based on an indication of a gap offset received from the MeNB 108.

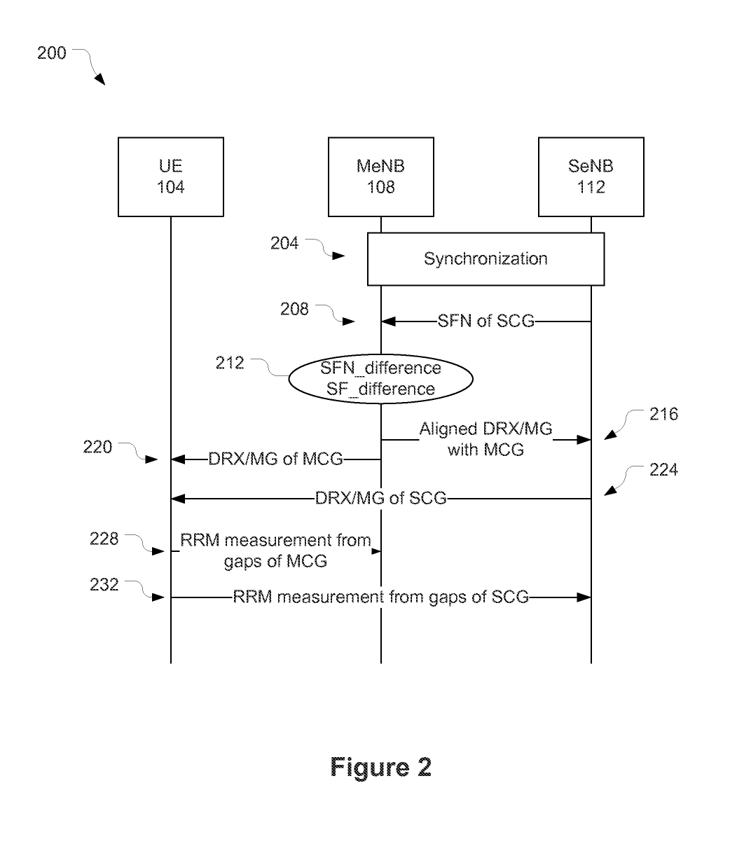

FIG. 2 is a message flow 200 illustrating a network-based configuration in a dual-connectivity environment, such as environment 100, in accordance with various embodiments.

The message flow 200 may include, at 204, synchronization of the MeNB 108 and the SeNB 112. The synchronization may include alignment circuitry 148 and alignment circuitry 170 synchronizing clocks of respective devices using any of a variety of synchronization procedures. In various embodiments, the synchronization procedures may be, but are not limited to, a global positioning satellite (GPS) synchronization procedure, an Institute of Electrical and Electronics Engineers (IEEE) 1588-2008 (also referred to as precision time protocol (PTP) version 2) synchronization procedure, or an open and closed loop network listening synchronization procedure. For example, in one embodiment, the alignment circuitries 148 may each connect with, and synchronize to, a GPS system. This may enable, for example, synchronization of the timing of the subframes of the MCG and the SCG without having to rely on direct communications between the SeNB 112 and the MeNB 108.

The message flow 200 may further include, at 208, the transmitter circuitry 160 of the SeNB 112 transmitting, e.g., in a physical broadcast channel, an indication of an SFN of the SCG to the receiver circuitry 144 of the MeNB 108. The message at 208 may be, for example, an SCG modification request initiated by the SeNB 112. In various embodiments, the SFN of the SCG, SFNSCG, may be represented by an SFN index of all the cells of the SCG at a particular point in time, for example, the time at which the message at 208 is transmitted. In some embodiments, the SFN index may be a number from 0-1023, with consecutive SFN indices representing a 10 ms interval, for example.

At 212, the determination circuitry 152 of the MeNB 108 may determine differences between the SFNs of the MCG and the SCG, SFN_difference or ΔSFN.

The term of the SFN timing difference, ΔSFN, may be represented as:

ΔSFN=SFNMCG−SFNSCG, Equation 1

where SFNMCG is an SFN index of all cells in the MCG.

Each SFN may be associated with a number of subframe numbers to provide more precise timing indications. Therefore, in some embodiments, in addition to determining the SFN_difference, the determination circuitry 152 may, at 212, determine differences between the subframes of the MCG and the SCG, SF_difference.

The determination circuitry 152 of the MeNB 108 may determine a subframe of the SCG based on GPS. In some embodiments, the MeNB 108 may get absolute timing information of SCG-transmitted subframes by GPS. This may allow the MeNB 108 to determine the correct start subframe index of gap/DRX. In some embodiments, the subframe may be represented by a subframe index that is a number from 0-9, with consecutive subframe indices representing a 1 ms interval within a particular SFN.

The subframe granularity may be desired to facilitate the DRX or measurement gap configuration, which may be based on a subframe index. For example, a radio resource control (RRC) layer may control DRX timers (for example, onDurationTimer, drx-InactivityTimer, drx-RetransmissionTimer) based on subframe indices.

Similarly, measurement gap occasion may be configured by a gapOffset within a measGapConfig information element (IE). Each measurement gap may start at a SFN and subframe meeting the following condition:

SFN mod T=FLOOR(gapOffset/10);

subframe=gapOffset mod 10,
with T=a measurement gap reception period (MGRP)/10.

The determination circuitry 152 may provide the determined SFN_difference and SF_difference to the alignment circuitry 148 of the MeNB 108. The alignment circuitry 148 may then configure a gap offset to align a DRX or measurement gap of the SCG with a DRX or measurement gap of the MCG from the perspective of the UE 104. The gap offset may include an SFN and subframe offset.

The message flow 200 may include, at 216, the transmitter circuitry 140 of the MeNB 108 transmitting an indication of the gap offset to the receiver circuitry 164 of the SeNB 112 in an aligned DRX/measurement gap with MCG message.

The message flow 200 may include, at 220, the transmitter circuitry 140 of the MeNB 108 transmitting an indication of the DRX or measurement gap of the MCG to the receiver circuitry 128 of the UE 104.

The alignment circuitry 170 of the SeNB 112 may, upon receiving the indication of the gap offset transmitted at 216, align the DRX or measurement gap of the SCG with the DRX or measurement gap of the MCG. In some embodiments, aligning the DRX or measurement gap may mean that the start timing of the DRX/measGap of the SCG is changed so that it is the same as the start timing of the DRX/measGap of the MCG, even if the start SFN/subframe index of the DRX/measGap of the SCG is different from the start SFN/subframe index of the DRX/measGap of the MCG. For example, both MCG and the SCG DRX/measGap may happen at time t, even if the SFN of MCG is “i,” and the SFN of the SCG is “i+SFN_offset.”

The transmitter circuitry 160 of the SeNB 112 may then, at 224, transmit an indication of the DRX or measurement gap of the SCG to the receiver circuitry 128 of the UE 104.

In the event that the indication of the DRX or measurement gap transmitted at 220 and 224 includes an indication of the measurement gap, the measurement circuitry 132 of the UE 104 may perform various RRM measurements based on the received indication. The transmitter circuitry 124 may then transmit an indication of the RRM measurements from the gaps of the MCG to the MeNB 108 at 228. Similarly, the transmitter circuitry 124 may transmit an indication of the RRM measurements from gaps of the SCG to the SeNB 112 at 232.

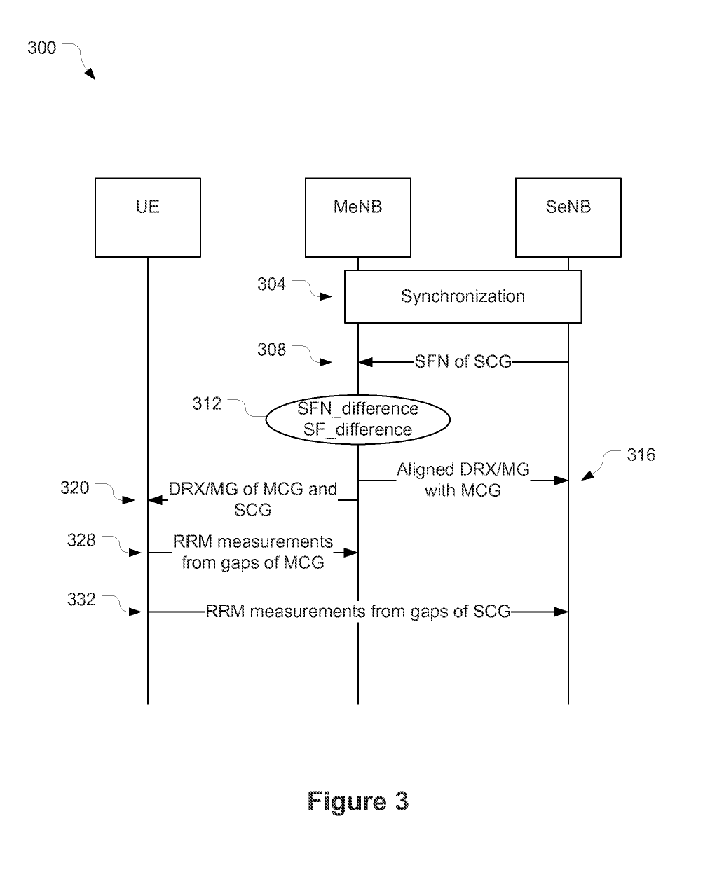

FIG. 3 is a message flow 300 illustrating a network-based configuration in a dual-connectivity environment, such as environment 100 in accordance with various embodiments. The message flow 300 may include messages/operations 304, 308, 312, 316, 328, and 332 that may be similar to corresponding messages/operations 204, 208, 212, 216, 228, and 232 described above with respect to FIG. 2. However, in this embodiment, the message flow 300 may, at 320, include the transmitter circuitry 140 of the MeNB 108 transmitting an indication of the DRX or measurement gap corresponding to both the MCG and SCG to the receiver circuitry 128 of the UE 104.

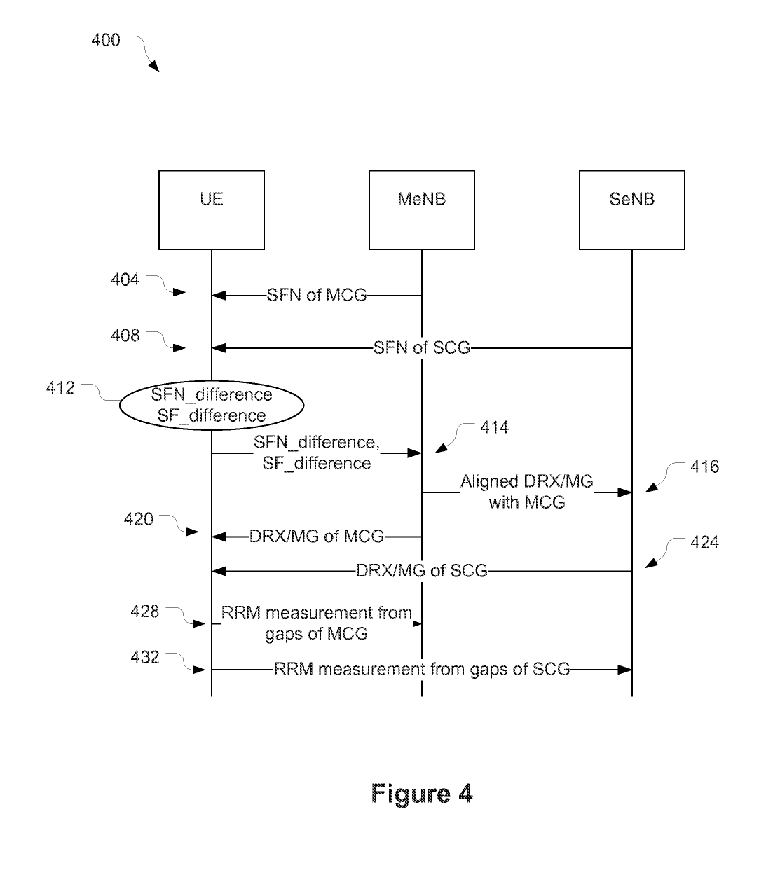

FIG. 4 is a message flow 400 illustrating a UE-based configuration in a dual-connectivity environment, such as environment 100, in accordance with various embodiments.

The UE-based configuration may rely on the UE 104 detecting the SFN indices of the MCG and the SCG. For example, the SFN index of the MCG may be known by the UE 104 detecting one or more master information blocks (MIBs) within a serving cell of the MCG (denoted as PCell). The SFN index of the SCG may be known by the UE 104 detecting one or more MIBs in a special cell of the SCG (denoted as pSCell). The pSCell of the SCG may be the cell that the UE 104 consistently monitors for broadcast information, whereas other cells of the SCG may be monitored for broadcast information sporadically or not at all.

The message flow 400 may include, at 404, the transmitter circuitry 140 of the MeNB 108 transmitting an indication of the SFN of the MCG to the receiver circuitry 128 of the UE 104. As noted above, the SFN index of the MCG may be provided in an MIB broadcast by the MeNB 108 in a PCell.

A message flow 400 may include, at 408, the transmitter circuitry 160 of the SeNB 112 transmitting an indication of the SFN of the SCG to the receiver circuitry 128 of the UE 104. As noted above, the SFN index of the SCG may be provided in an MIB broadcast by the SeNB 112 in a pSCell.

In the present embodiment, the UE 104 may include determination circuitry 136 that is configured to determine the SFN_difference and SF_difference similar to that described above with respect to determination circuitry 152 of the MeNB 108. Upon determination, the transmitter circuitry 124 of the UE 104 may, at 414, transmit an indication of the SFN_difference and SF_difference to the receiver circuitry 144 of the MeNB 108. In this embodiment, the determination circuitry 152 of the MeNB 108 may be considered to determine the SFN_difference and SF_difference based on the indications transmitted from the UE 104.

The alignment circuitry 148 of the MeNB 108 may, upon receiving the indications of the SFN_difference and SF_difference from the UE 104, determine a gap offset in a process similar to that described above with respect to FIG. 2.

The message flow 400 may include messages/operations 416, 420, 424, 428, and 432 that may be similar to corresponding messages/operations 216, 220, 224, 228, and 232 described above with respect to FIG. 2.

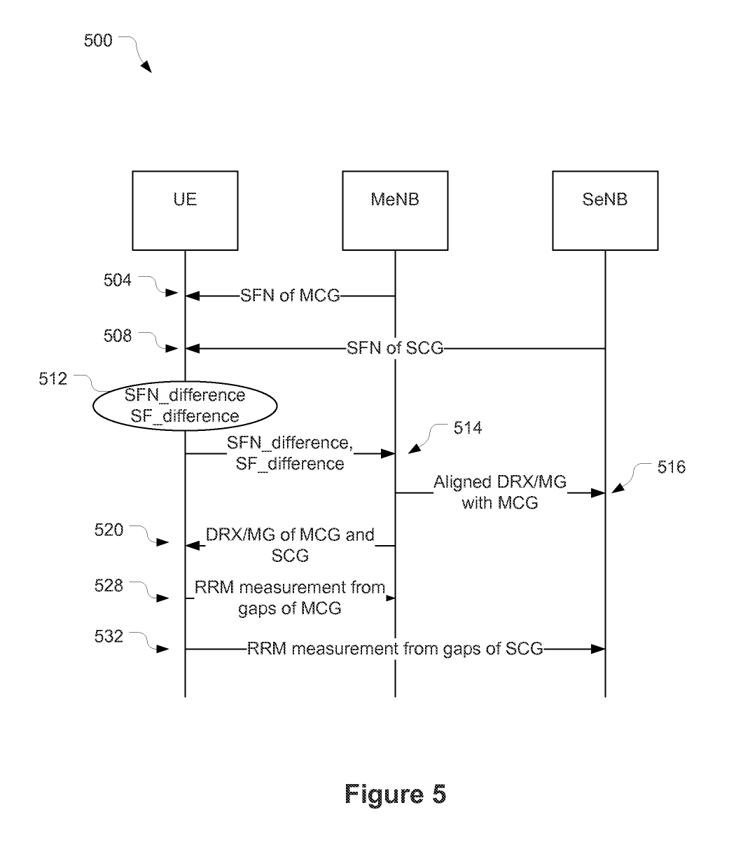

FIG. 5 is a message flow 500 illustrating another UE-based configuration in a dual-connectivity environment, such as environment 100 in accordance with various embodiments. The message flow 500 may include messages/operations 504, 508, 512, 514, 516, 528, and 532 that may be similar to corresponding messages/operations 404, 408, 412, 414, 416, 428, and 432 described above with respect to FIG. 4. However, in this embodiment, the message flow 500 may, at 520, include the transmitter circuitry 140 of the MeNB 108 transmitting an indication of the DRX or measurement gap corresponding to both the MCG and SCG to the receiver circuitry 128 of the UE 104.

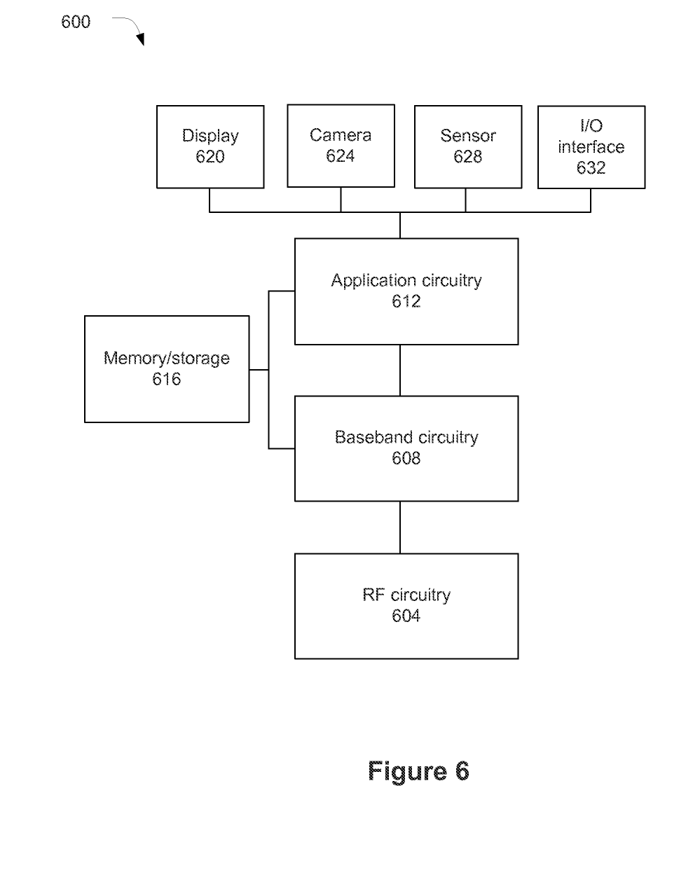

The UE 104, MeNB 108, or SeNB 112 as described herein may be implemented into a system using any suitable hardware, firmware, or software configured as desired. FIG. 6 illustrates, for one embodiment, an example system 600 comprising radio frequency (RF) circuitry 604, baseband circuitry 608, application circuitry 612, memory/storage 616, display 620, camera 624, sensor 628, and input/output (I/O) interface 632, coupled with each other at least as shown.

The application circuitry 612 may include circuitry such as, but not limited to, one or more single-core or multi-core processors. The processor(s) may include any combination of general-purpose processors and dedicated processors (e.g., graphics processors, application processors, etc.). The processors may be coupled with memory/storage 616 and configured to execute instructions stored in the memory/storage 616 to enable various applications or operating systems running on the system 600.

The baseband circuitry 608 may include circuitry such as, but not limited to, one or more single-core or multi-core processors. The processor(s) may include a baseband processor. The baseband circuitry 608 may handle various radio control functions that enable communication with one or more radio networks via the RF circuitry 604. The radio control functions may include, but are not limited to, signal modulation, encoding, decoding, radio frequency shifting, etc. In some embodiments, the baseband circuitry 608 may provide for communication compatible with one or more radio technologies. For example, in some embodiments, the baseband circuitry 608 may support communication with an E-UTRAN or other wireless metropolitan area networks (WMAN), a wireless local area network (WLAN), or a wireless personal area network (WPAN). Embodiments in which the baseband circuitry 608 is configured to support radio communications of more than one wireless protocol may be referred to as multi-mode baseband circuitry.

In various embodiments, baseband circuitry 608 may include circuitry to operate with signals that are not strictly considered as being in a baseband frequency. For example, in some embodiments, baseband circuitry 608 may include circuitry to operate with signals having an intermediate frequency, which is between a baseband frequency and a radio frequency.

In some embodiments, the determination circuitry 136 or 152, alignment circuitry 148 or 170, or the measurement circuitry 132 may be embodied in the application circuitry 612 or the baseband circuitry 608.

RF circuitry 604 may enable communication with wireless networks using modulated electromagnetic radiation through a non-solid medium. In various embodiments, the RF circuitry 604 may include switches, filters, amplifiers, etc., to facilitate the communication with the wireless network.

In various embodiments, RF circuitry 604 may include circuitry to operate with signals that are not strictly considered as being in a radio frequency. For example, in some embodiments, RF circuitry 604 may include circuitry to operate with signals having an intermediate frequency, which is between a baseband frequency and a radio frequency.

In some embodiments, the wireless transceivers 116, 136, or 156 may be embodied in the RF circuitry 604.

In some embodiments, some or all of the constituent components of the baseband circuitry 608, the application circuitry 612, or the memory/storage 616 may be implemented together on a system on a chip (SOC).

Memory/storage 616 may be used to load and store data or instructions, for example, for system 600. Memory/storage 616 for one embodiment may include any combination of suitable volatile memory (e.g., dynamic random access memory (DRAM)) or non-volatile memory (e.g., Flash memory).

In various embodiments, the I/O interface 632 may include one or more user interfaces designed to enable user interaction with the system 600 or peripheral component interfaces designed to enable peripheral component interaction with the system 600. User interfaces may include, but are not limited to, a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, sensor 628 may include one or more sensing devices to determine environmental conditions or location information related to the system 600. In some embodiments, the sensors may include, but are not limited to, a gyro sensor, an accelerometer, a proximity sensor, an ambient light sensor, and a positioning unit. The positioning unit may also be part of, or interact with, the baseband circuitry 608 or RF circuitry 604 to communicate with components of a positioning network, e.g., a global positioning system (GPS) satellite.

In various embodiments, the display 620 may include a display (e.g., a liquid crystal display, a touch screen display, etc.).

In various embodiments, the system 600 may be a mobile computing device such as, but not limited to, a laptop computing device, a tablet computing device, a netbook, an ultrabook, a smartphone, etc. In various embodiments, system 600 may have more or fewer components, or different architectures.

The following paragraphs describe examples of various embodiments.

Example 1 includes a master evolved node B (MeNB) circuitry comprising: determination circuitry to: determine a difference between a system frame number (SFN) of a secondary cell group (SCG) and a SFN of a master cell group (MCG); and determine a difference between the subframe number of the SCG and a subframe number of the MCG; and alignment circuitry, coupled with the determination circuitry, to: configure a gap offset to align a discontinuous reception (DRX) or measurement gap of the SCG with a DRX or measurement gap of the MCG.

Example 2 includes the MeNB circuitry of Example 1, wherein the gap offset is to align a DRX or measurement gap of the SCG with a DRX and measurement gap of the MCG with a subframe granularity.

Example 3 includes the MeNB circuitry of Example 1 or 2, further comprising: receiver circuitry to receive an indication of the SFN of the SCG from a secondary evolved node B (SeNB), wherein the determination circuitry is to determine the difference between the SFN of the SCG and the SFN of the MCG based on the received indication.

Example 4 includes the MeNB circuitry of any of Examples 1-2, further comprising: receiver circuitry to receive an indication of the difference between the SFN of the SCG and the SFN of the MCG from a user equipment (UE), wherein the determination circuitry is to determine the difference based on the received indication.

Example 5 includes the MeNB circuitry of any of Examples 1-4, further comprising: transmitter circuitry, coupled with the alignment circuitry, to transmit an indication of the gap offset to an SeNB associated with the SCG.

Example 6 includes the MeNB circuitry of Example 5, wherein the transmitter circuitry is further to transmit an indication of the DRX or measurement gap of the MCG to a user equipment (UE).

Example 7 includes the MeNB circuitry of Example 6, wherein the transmitter circuitry is further to transmit the DRX or measurement gap of the SCG to the UE.

Example 8 includes the MeNB circuitry of Example 6, wherein the transmitter circuitry is to transmit the measurement gap of the MCG and the MeNB further comprises: receiver circuitry to receive an indication of a radio resource management (RRM) measurement from the UE based on the measurement gap.

Example 9 includes the MeNB of any of Examples 1-8, wherein the determination circuitry is to synchronize with the SeNB to determine the difference between the subframe number of the SCG and the subframe number of the MCG.

Example 10 includes a secondary evolved node B (SeNB) circuitry comprising: transmitter circuitry to transmit an indication of a system frame number (SFN) of a secondary cell group (SCG) associated with the SeNB; receiver circuitry to receive an indication of a gap offset from a master evolved node B (MeNB); and alignment circuitry to align a discontinuous reception (DRX) or measurement gap of the SCG with a DRX or measurement gap of a master cell group (MCG) associated with the MeNB based on the received indication of the gap offset.

Example 11 includes the SeNB of Example 10, wherein the transmitter circuitry is to transmit the indication of the SFN of the SCG to the MeNB.

Example 12 includes the SeNB of Example 10 or 11, wherein the transmitter circuitry is to transmit the indication of the SFN of the SCG to a user equipment (UE).

Example 13 includes the SeNB of any of Examples 10-12, wherein the transmitter circuitry is to transmit an indication of the DRX or measurement gap of the SCG to a user equipment (UE).

Example 14 includes the SeNB of any of Examples 10-13, wherein the transmitter circuitry is to transmit an indication of a measurement gap of the SCG and the receiver circuitry is to receive an indication of a radio resource management (RRM) measurement from a user equipment (UE) based on the measurement gap.

Example 15 includes the SeNB of any of Examples 10-14, wherein the alignment circuitry is to synchronize with the MeNB to facilitate a determination of a subframe number difference between the SCG and the MCG.

Example 16 includes the SeNB of Example 15, wherein the alignment circuitry is to synchronize with the MeNB using a global positioning satellite (GPS) synchronization procedure, an Institute of Electrical and Electronics Engineers (IEEE) 1588-2008 synchronization procedure, an open-loop network listening synchronization procedure, or a closed-loop network listening synchronization procedure.

Example 17 includes a user equipment circuitry comprising: receiver circuitry to receive an indication of a system frame number (SFN) of a master cell group (MCG) and an indication of a SFN of a secondary cell group (SCG); determination circuitry, coupled with the receiver circuitry, to determine a difference between the SFN of the MCG and the SFN of the SCG; and transmitter circuitry to transmit an indication of the difference between the SFN of the MCG and the SFN of the SCG to a master evolved node B (MeNB) associated with the MCG.

Example 18 includes the UE circuitry of Example 17, wherein the receiver circuitry is further to receive an indication of a discontinuous reception (DRX) or measurement gap of the MCG from the MeNB.

Example 19 includes the UE circuitry of Example 18, wherein the receiver circuitry is to receive an indication of a measurement gap of the MCG and the UE circuitry further comprises: measurement circuitry to perform a radio resource management (RRM) measurement based on the measurement gap, wherein the transmitter circuitry is coupled with the measurement circuitry and is to transmit an indication of the RRM measurement to the MeNB.

Example 20 includes the UE circuitry of any of Examples 17-19, wherein the receiver circuitry is to receive an indication of a measurement gap of the SCG and the UE circuitry further comprises: measurement circuitry to perform a radio resource management (RRM) measurement based on the measurement gap, wherein the transmitter circuitry is coupled with the measurement circuitry and is to transmit an indication of the RRM measurement to a secondary evolved node B (SeNB).

Example 21 includes the UE circuitry of Example 20, wherein the receiver circuitry is to receive the indication of the measurement gap of the SCG from the MeNB.

Example 22 includes the UE circuitry of Example 20, wherein the receiver circuitry is to receive the indication of the measurement gap of the SCG from the SeNB.

Example 23 includes a method comprising: determining a difference between a system frame number (SFN) of a secondary cell group (SCG) and a SFN of a master cell group (MCG); determining a difference between the subframe number of the SCG and a subframe number of the MCG; and configuring a gap offset to align a discontinuous reception (DRX) or measurement gap of the SCG with a DRX or measurement gap of the MCG.

Example 24 includes the method of Example 23, wherein the gap offset is to align a DRX or measurement gap of the SCG with a DRX and measurement gap of the MCG with a subframe granularity.

Example 25 includes the method of Example 23 or 24, further comprising: receiving an indication of the SFN of the SCG from a secondary evolved node B (SeNB), wherein the determining the difference between the SFN of the SCG and the SFN of the MCG is based on the received indication.

Example 26 includes the method of any of Examples 23-25, further comprising: receiving an indication of the difference between the SFN of the SCG and the SFN of the MCG from a user equipment (UE), wherein the determination circuitry is to determine the difference based on the received indication.

Example 27 includes the method of any of Examples 23-26, further comprising: transmitting an indication of the gap offset to an SeNB associated with the SCG.

Example 28 includes the method of Example 27, wherein transmitting of the indication of the DRX or measurement gap of the MCG is to a user equipment (UE).

Example 29 includes the method of Example 28, wherein the transmitting of the DRX or measurement gap of the SCG is to the UE.

Example 30 includes the method of Example 28, further comprising: receiving an indication of a radio resource management (RRM) measurement from the UE based on the measurement gap.

Example 31 includes the method of any of Examples 23-30, further comprising synchronizing with the SeNB to determine the difference between the subframe number of the SCG and the subframe number of the MCG.

Example 32 includes a method comprising: transmitting an indication of a system frame number (SFN) of a secondary cell group (SCG) associated with a secondary evolved node B (SeNB); receiving an indication of a gap offset from a master evolved node B (MeNB); and aligning a discontinuous reception (DRX) or measurement gap of the SCG with a DRX or measurement gap of a master cell group (MCG) associated with the MeNB based on the received indication of the gap offset.

Example 33 includes the method of Example 32, wherein the transmitting of the indication of the SFN of the SCG is to the MeNB.

Example 34 includes the method of Example 32 or 33, wherein the transmitting of the indication of the SFN of the SCG is to a user equipment (UE).

Example 35 includes the method of any of Examples 32-34, further comprising transmitting an indication of the DRX or measurement gap of the SCG to a user equipment (UE).

Example 36 includes the method of any of Examples 32-35, further comprising transmitting an indication of a measurement gap of the SCG and receiving an indication of a radio resource management (RRM) measurement from a user equipment (UE) based on the measurement gap.

Example 37 includes the method of any of Examples 32-36, wherein the synchronizing with the MeNB is to facilitate a determination of a subframe number difference between the SCG and the MCG.

Example 38 includes the method of Example 37, further comprising synchronizing with the MeNB using a global positioning satellite (GPS) synchronization procedure, an Institute of Electrical and Electronics Engineers (IEEE) 1588-2008 synchronization procedure, an open-loop network listening synchronization procedure, or a closed-loop network listening synchronization procedure.

Example 39 includes one or more non-transitory computer-readable media having instructions, when executed by one or more processors, perform the method of any of Examples 23-38.

The description herein of illustrated implementations, including what is described in the Abstract, is not intended to be exhaustive or to limit the present disclosure to the precise forms disclosed. While specific implementations and examples are described herein for illustrative purposes, various equivalent modifications are possible within the scope of the disclosure, as those skilled in the relevant art will recognize. These modifications may be made to the disclosure in light of the above detailed description.

What is claimed is:

1. Master enhanced node B (MeNB) circuitry comprising:
determination circuitry to:
determine a difference between a system frame number (SFN) of a secondary cell group (SCG) and a SFN of a master cell group (MCG); and
determine a difference between the subframe number of the SCG and a subframe number of the MCG; and
alignment circuitry, coupled with the determination circuitry, to:
configure a gap offset to align a discontinuous reception (DRX) or measurement gap of the SCG with a DRX or measurement gap of the MCG.

2. The MeNB circuitry of claim 1, wherein the gap offset is to align a DRX or measurement gap of the SCG with a DRX and measurement gap of the MCG with a subframe granularity.

3. The MeNB circuitry of claim 1, further comprising:
receiver circuitry to receive an indication of the SFN of the SCG from a secondary enhanced node B (SeNB),
wherein the determination circuitry is to determine the difference between the SFN of the SCG and the SFN of the MCG based on the received indication.

4. The MeNB circuitry of claim 1, further comprising:
receiver circuitry to receive an indication of the difference between the SFN of the SCG and the SFN of the MCG from a user equipment (UE),
wherein the determination circuitry is to determine the difference based on the received indication.

5. The MeNB circuitry of claim 1, further comprising:
transmitter circuitry, coupled with the alignment circuitry, to transmit an indication of the gap offset to an SeNB associated with the SCG.

6. The MeNB circuitry of claim 5, wherein the transmitter circuitry is further to transmit an indication of the DRX or measurement gap of the MCG to a user equipment (UE).

7. The MeNB circuitry of claim 6, wherein the transmitter circuitry is further to transmit the DRX or measurement gap of the SCG to the UE.

8. The MeNB circuitry of claim 6, wherein the transmitter circuitry is to transmit the measurement gap of the MCG and the MeNB further comprises:
receiver circuitry to receive an indication of a radio resource management (RRM) measurement from the UE based on the measurement gap.

9. The MeNB of claim 1, wherein the determination circuitry is to synchronize with the SeNB to determine the difference between the subframe number of the SCG and the subframe number of the MCG.

10. Secondary enhanced node B (SeNB) circuitry comprising:
transmitter circuitry to transmit an indication of a system frame number (SFN) of a secondary cell group (SCG) associated with the SeNB;
receiver circuitry to receive an indication of a gap offset from a master enhanced node B (MeNB); and
alignment circuitry to align a discontinuous reception (DRX) or measurement gap of the SCG with a DRX or measurement gap of a master cell group (MCG) associated with the MeNB based on the received indication of the gap offset.

11. The SeNB of claim 10, wherein the transmitter circuitry is to transmit the indication of the SFN of the SCG to the MeNB.

12. The SeNB of claim 10, wherein the transmitter circuitry is to transmit the indication of the SFN of the SCG to a user equipment (UE).

13. The SeNB of claim 10, wherein the transmitter circuitry is to transmit an indication of the DRX or measurement gap of the SCG to a user equipment (UE).

14. The SeNB of claim 10, wherein the transmitter circuitry is to transmit an indication of a measurement gap of the SCG and the receiver circuitry is to receive an indication of a radio resource management (RRM) measurement from a user equipment (UE) based on the measurement gap.

15. The SeNB of claim 10, wherein the alignment circuitry is to synchronize with the MeNB to facilitate a determination of a subframe number difference between the SCG and the MCG.

16. The SeNB of claim 15, wherein the alignment circuitry is to synchronize with the MeNB using a global positioning satellite (GPS) synchronization procedure, an Institute of Electrical and Electronics Engineers (IEEE) 1588-2008 synchronization procedure, an open-loop network listening synchronization procedure, or a closed-loop network listening synchronization procedure.

17. User equipment circuitry comprising:
receiver circuitry to receive an indication of a system frame number (SFN) of a master cell group (MCG) and an indication of a SFN of a secondary cell group (SCG);
determination circuitry, coupled with the receiver circuitry, to determine a difference between the SFN of the MCG and the SFN of the SCG; and
transmitter circuitry to transmit an indication of the difference between the SFN of the MCG and the SFN of the SCG to a master enhanced node B (MeNB) associated with the MCG.

18. The UE circuitry of claim 17, wherein the receiver circuitry is further to receive an indication of a discontinuous reception (DRX) or measurement gap of the MCG from the MeNB.

19. The UE circuitry of claim 18, wherein the receiver circuitry is to receive an indication of a measurement gap of the MCG and the UE circuitry further comprises:
measurement circuitry to perform a radio resource management (RRM) measurement based on the measurement gap,
wherein the transmitter circuitry is coupled with the measurement circuitry and is to transmit an indication of the RRM measurement to the MeNB.

20. The UE circuitry of claim 17, wherein the receiver circuitry is to receive an indication of a measurement gap of the SCG and the UE circuitry further comprises:
measurement circuitry to perform a radio resource management (RRM) measurement based on the measurement gap,
wherein the transmitter circuitry is coupled with the measurement circuitry and is to transmit an indication of the RRM measurement to a secondary enhanced node B (SeNB).

21. The UE circuitry of claim 20, wherein the receiver circuitry is to receive the indication of the measurement gap of the SCG from the MeNB.

22. The UE circuitry of claim 20, wherein the receiver circuitry is to receive the indication of the measurement gap of the SCG from the SeNB.
